(19) United States
(12) Patent Application Publication
(10) Pub. No.: US 2010/0117272 A1
(43) Pub. Date: May 13, 2010

(54) Method Of Increasing Ceramic Paste Stiffening/Gelation Temperature By Using Organic Additive Urea

(76) Inventor: MICHAEL EDWARD DEROSA, PAINTED POST, NY (US)

Correspondence Address: CORNING INCORPORATED, SP-TI-3-1, CORNING, NY, 14831, US

(21) Appl. No.: 12/270,113

(22) Filed: Nov. 13, 2008

(51) Int. Cl. C04B 35/46

(52) U.S. Cl. 264/631; 501/95.2

(57) ABSTRACT

The present invention provides a ceramic precursor batch composition comprising inorganic ceramic-forming ingredients, a binder, an aqueous solvent and a chaotropic agent. The chaotropic agent can be urea, methylurea, ethylurea, n-butylurea, 1,3-dimethylurea, ethyleneurea, 1,1-dimethylurea, tetramethylurea, thiourea or mixtures thereof. The presence of the chaotropic agent provides a composition with a lower viscosity and/or a greater batch stiffening temperature allowing for increased rates of extrusion. Methods for producing a ceramic honeycomb body using the ceramic precursor batch composition of the present invention are also provided.

### BACKGROUND

The present invention relates generally to ceramic precursor batch compositions, and particularly to ceramic precursor batch compositions comprising chaotropic agents.

Diesel and automotive pollution control products are in strong demand. In response to this growing demand, there is a need to increase the feedrate of cordierite and aluminum titanate (AT)-based compositions on a twin screw extrusion machine. However, there is a maximum extrusion feedrate limit due to an upper limiting temperature at which the ceramic batches can be extruded. At a characteristic batch stiffening temperature, historically known as the batch gelation temperature, the rheological behavior of the ceramic paste begins to change. The batch begins to change its rheological properties because the hydroxypropyl methylcellulose (HPMC) binder undergoes phase separation and subsequent gelation at a specific temperature. These changes can lead to differential flow behavior between the core and skin of the ware due to radial temperature gradients caused by shear induced heating of the paste. In the most extreme case, when the temperature becomes much higher than the batch stiffening temperature, the paste viscosity can increase to the point where it can cause the extruder torque and die pressure to reach their maximum limits. Therefore, there is a strong need to increase the batch stiffening temperature by providing a modification to cordierite and AT organic packages.

In the past the batch stiffening temperature of ceramic compositions has been increased by using hydroxypropyl methylcellulose binders that have higher hydroxypropyl substitution levels as are found in “K-type” binders. F-type binders have even been blended with K-type binders to increase the batch stiffening temperature Until now, blending binders with different substitution chemistry has been the only materials-based approach used to increase the batch stiffening temperature. However, using a K-type binder alone can cause other problems such as poor wet and knit strength during extrusion as well as blister formation on the skin during drying.

Therefore, there is a need for an alternative materials solution that will increase the stiffening temperature of ceramic pastes and, as a result, increase extrusion feedrates.

### SUMMARY

In one aspect disclosed herein there is provided a method of producing a ceramic honeycomb body, comprising the steps of providing inorganic ceramic-forming ingredients, adding a cellulose-based binder, an aqueous-based solvent, and a chaotropic agent to the inorganic ceramic-forming ingredients, wherein the chaotropic agent is optionally pre-mixed with the aqueous-based solvent, wherein the chaotropic agent is urea, a urea derivative or mixtures thereof, mixing the inorganic ceramic-forming ingredients, the binder, the solvent, and the chaotropic agent to form a precursor batch, forming the precursor batch into a green honeycomb body and firing the green honeycomb body to produce the ceramic honeycomb body. The chaotropic agent can be urea, methylurea, ethylurea, n-butylurea, 1,3-dimethylurea, ethyleneurea, 1,1-dimethylurea, tetramethylurea, thiourea or mixtures thereof.

In another aspect disclosed herein there is provided a method of producing a ceramic precursor batch, comprising the steps of providing inorganic ceramic-forming ingredients and adding a cellulose-based binder, an aqueous-based solvent, and a chaotropic agent to the inorganic ceramic-forming ingredients to form the ceramic precursor batch, wherein the chaotropic agent is optionally mixed with the aqueous-based solvent prior to adding to the inorganic ceramic-forming ingredients, wherein the chaotropic agent is urea, a urea derivative or mixtures thereof.

In a further aspect disclosed herein there is provided a ceramic precursor batch composition, comprising inorganic ceramic-forming ingredients, a cellulose-based binder, an aqueous based solvent and a chaotropic agent, wherein the chaotropic agent is urea, a urea derivative or mixtures thereof.

Additional features and advantages of the invention will be set fort in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

The accompanying drawings illustrate certain embodiments of the disclosure.

FIG. 1 is a graphical representation of capillary temperature sweep results for various aluminum titanate based batches including a control batch (no urea), and batches with 1, 2, and 4% urea

FIG. 2 is a graphical representation of capillary temperature sweep results for various cordierite based batches including a control batch (no urea), and batches with 3 and 5% urea

### DETAILED DESCRIPTION

The present invention provides a ceramic precursor batch composition with a higher stiffening onset temperature, allowing for greater extrusion federates without significant increases in pressure. The composition can comprise inorganic ceramic-forming ingredients, a cellulose-based binder, an aqueous solvent such as, but not limited to, water and a chaotropic agent. The chaotropic agent can be urea, methylurea, ethylurea, n-butylurea, 1,3-dimethylurea, ethyleneurea, 1,1-dimethylurea, tetramethylurea, thiourea or mixtures thereof. There is also provided a method of producing a ceramic honeycomb body comprising using such ceramic precursor batch composition.

The ceramic precursor batch composition disclosed herein comprises at least one chaotropic agent to provide a batch composition that has a higher stiffening onset temperature, a lower pressure during extrusion and a greater feedrate than the ceramic precursor batch compositions of the prior art that do not comprise a chaotropic agent. The chaotropic agent can be urea or an organic urea compound. While not wishing to be bound by theory, urea and organic ureas may increase the gelation temperature of the binder through hydrogen bonding interactions. Urea may attach to various sites on the binder by hydrogen bonding and inhibit intermolecular hydrogen bonding between individual binder molecules. Alternatively, urea may inhibit hydrophobic interactions between binder molecules. Urea may solvate hydrophobic residues along the binder molecule by replacing water molecules in the hydration layer of the binder. Regardless of which mechanism is correct, the outcome of both theories is that urea helps to disperse the binder molecules in aqueous solution and prevents them from aggregating, which leads to either gelling or phase separation at higher than normal temperatures.

In one embodiment, the chaotropic agent can be urea, methylurea, ethylurea, n-butylurea, 1,3-dimethylurea, ethyleneurea, 1,1-dimethylurea, tetramethylurea, thiourea or mixtures thereof. The chaotropic agent can be added to the batch composition in a concentration of from about 0.1 molal to about 8 molal. In an exemplary embodiment, the chaotropic agent has a molality of from about 0.5 molal to about 3 molal. The molality or molals of the chaotropic agent is the moles of chaotropic agent to kg of aqueous solvent. In an alternate exemplary embodiment, the chaotropic agent can be saturating, that is, it may be present in concentrations up to the solubility limit of the chaotropic agent. The amount of chaotropic agent in the ceramic precursor batch composition may depend on the composition itself, the method of forming a green body and/or the desired batch stiffening temperature. It is within the skill of those in the art to determine the optimal amount of chaotropic agent required without undue experimentation.

The inorganic ceramic-forming ingredients can be cordierite, mullite, clay, talc, zircon, zirconia, spinet, aluminas and their precursors, silicas and their precursors, silicates, aluminates, lithium aluminosilicates, feldspar, titania, fused silica, nitrides, carbides, borides, e.g., silicon carbide, silicon nitride, soda lime, aluminosilicate, borosilicate, soda barium borosilicate or combinations of these, as well as others. Combinations of these materials may be physical or chemical combinations, for example, mixtures or composites, respectively.

In one exemplary embodiment, the inorganic ceramic-forming ingredients may yield an aluminum-titanate ceramic material upon firing. In another exemplary embodiment, the inorganic ceramic-forming ingredients are those that yield cordierite, mullite, or mixtures of these on firing, some examples of such mixtures being about 2% to about 60% mullite, and about 30% to about 97% cordierite, with allowance for other phases, and in some embodiments up to about 10% by weight. Some suitable ceramic batch material compositions for forming cordierite are disclosed in U.S. Pat. No. 3,885,977 which is herein incorporated by reference as filed.

One composition, by way of a non-limiting example, which ultimately forms cordierite upon firing are as follows in percent by weight, although it is to be understood that the invention is not limited to such about 33-41, or even about 34-40 of aluminum oxide, about 46-53 or even about 48-52 of silica, and about 11-17 and or even about 12-16 magnesium oxide.

In practice, the ceramic precursor batch composition comprised of the chaotropic agent and an inorganic powder component consisting of a sinterable inorganic particulate material, e.g., a ceramic powder material, may be prepared by using the components in ally desired amounts selected.

The inorganic ceramic-forming ingredients may be synthetically produced materials such as oxides, hydroxides, etc., or they may be naturally occurring minerals such as clays, talcs, or any combination of these. The invention is not limited to the types of powders or raw materials. These may be chosen depending on the properties desired in the ceramic body.

The cellulose-based binder can be, but not limited to, methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxymethylcellulose, and mixtures thereof. Methylcellulose and/or methylcellulose derivatives can be especially suited as organic binders particularly methylcellulose, hydroxypropyl methylcellulose, or combinations of these. Sources of cellulose ethers include Methocel A4M, F4M and F240 cellulose products from Dow Chemical Co. Methocel A4M cellulose is a methylcellulose while Methocel F4M, and F240 cellulose products are hydroxypropyl methylcellulose.

The properties of suitable cellulose-based binders such as methylcellulose can include water retention, water solubility, surface activity or wetting ability, thickening of the mixture, providing wet and dry green strength to the green bodies, thermal gelation and hydrophobic association in an aqueous environment. In some embodiments, the cellulose ether binders promote hydrogen bonding interaction with the solvent. Non-limiting examples of substituent groups that maximize the hydrogen bonding interaction with polar solvents e.g. water, may be hydroxypropyl and hydroxyethyl groups, and to a smaller extent hydroxybutyl groups. The hydrophobically modified cellulose ether binder can make up in some embodiments, as a superaddition, about 1-10% by weight, and in other embodiments about 2-6% by weight of the inorganic ceramic-forming material.

The solvent can provide a medium for the binder to dissolve in, thus providing plasticity to the ceramic precursor batch and wetting of the powders. The solvent can be aqueous based such as, but not limited to, water or water-miscible solvents. Aqueous based solvents can provide hydration of the binder and powder particles. In some embodiments, the amount of aqueous solvent is from about 10% by weight to about 50% by weight. The chaotropic agent may reduce the viscosity of the ceramic precursor batch. Therefore it may be desirable to reduce the amount of aqueous solvent by, for example, about 1-2% by weight to give a ceramic precursor batch having the same viscosity or stiffness as compositions without the chaotropic agent but having a higher batch stiffening temperature. The lower amount of aqueous solvent may allow for faster drying of a green body formed from the ceramic precursor batch.

The ceramic precursor batch composition disclosed herein may further comprise other additives such as surfactants, oil lubricants and pore-forming material. Non-limiting examples of surfactants that may be used in the practice of the present invention are C₈ to C₂₂ fatty acids and/or their derivatives. Additional surfactant components that nay be used with these fatty acids are C₈ to C₂₂ fatty esters, C₈ to C₂₂ fatty alcohols, and combinations of these. Exemplary surfactants are stearic, lauric, myristic, oleic, linoleic, palmitic acids, and their derivatives, stearic acid in combination with ammonium lauryl sulfate, and combinations of all of these. In an illustrative embodiment, the surfactant is lauric acid, stearic acid, oleic acid, and combinations of these. In some embodiments, the amount of surfactants is from about 0.5% by weight to about 2% by weight.

Non-limiting examples of oil lubricants include light mineral oil, corn oil, high molecular weight polybutenes, polyol esters, a blend of light mineral oil and wax emulsion, a blend of paraffin wax in corn oil, and combinations of these. In some embodiments, the amount of oil lubricants is from about 1% by weight to about 10% by weight. In an exemplary embodiment, the oil lubricants is present from about 3% by weight to about 6% by weight.

In filter applications, such as in diesel particulate filters, it may be desirable to include a pore forming material in the mixture in an amount effective to subsequently obtain the porosity required for efficient filtering. A pore forming material is any particulate substance (not a binder) that burns out of the green body in the firing step. Although it is to be understood that the invention is not limited to these, in some embodiments the pore forming materials include non-waxy organics that are solid at room temperature, elemental carbon, and combinations of these. Some examples are graphite, starch, cellulose, flour, etc. In one exemplary embodiment, the pore forming material is elemental carbon. In another exemplary embodiment, the pore forming material is graphite. In some embodiments, graphite has the least adverse effect on the processing. In an extrusion process, for example, the rheology of the mixture may be good when graphite is used. Alternatively, gas or gas producing pore forming materials can also be used. In some embodiments, the pore forming material is up to about 60% by weight as a superaddition. In some embodiments, the amount of graphite is from about 10% to about 30%, and in other embodiments about 15% to about 30% by weight based on the inorganic ceramic-forming ingredients. If a combination of graphite and flour are used, the amount of pore forming material in some embodiments is from about 10% by weight to about 25% by weight with the graphite at 5% by weight to 11% of each and the flour at 5% by weight to about 10% by weight.

Also disclosed herein is a method of producing a ceramic honeycomb body, comprising the steps of providing inorganic ceramic-forming ingredients and adding a cellulose-based binder, an aqueous based solvent and a chaotropic agent to the inorganic ceramic-forming ingredients. In some embodiments, the chaotropic agent is urea, methylurea, ethylurea, n-butylurea, 1,3-dimethylurea, ethyleneurea, 1,1-dimethylurea, tetramethylurea, thiourea or mixtures thereof. In some embodiments, the chaotropic agent has a molality of from about 0.1 molal to about 8 molal. In an exemplary embodiment, the chaotropic agent has a molality of from about 0.5 molal to about 3 molal. The molality or molals of the chaotropic agent is the ratio of moles of chaotropic agent to kg of aqueous solvent. In an alternate exemplary embodiment, the chaotropic agent is saturating, that is, it may be present in concentrations up to the solubility limit of the chaotropic agent.

The inorganic ceramic-forming ingredients, the binder, the solvent and the chaotropic agent are then mixed to form a precursor batch. The inorganic materials, binder, solvent and chaotropic agent may be mixed in a muller or Littleford mixer. The solvent can be added in an amount that is less than is needed to plasticize the batch. With water as the solvent, the water hydrates the binder and the powder particles. The surfactant and/or oil lubricant, if desired, may then be added to the mix to wet out the binder and powder particles.

The precursor batch can then be plasticized by shearing the wet mix formed above in any suitable mixer in which the batch will be plasticized, such as, but not limited to, a twin-screw extruder/mixer, auger mixer, muller mixer, or double arm, etc. Extent of plasticization is dependent on the concentration of the components (binder, solvent, chaotropic agent, surfactant, oil lubricant and the inorganics), temperature of the components, the amount of work put in to the batch, the shear rate, and extrusion velocity. During plasticization, the binder dissolves in the solvent and a gel is formed. The gel that is formed is stiff because the system is very solvent deficient. The surfactant enables the binder-gel to adhere to the powder particles.

In a further step, the composition may be extruded, such as through an extrusion die or a forming die, to form a green honeycomb body. Extrusion may be done with devices that provide low to moderate shear. For example hydraulic ram extrusion press or two stage de-airing single auger are low shear devices. A single screw extruder is a moderate shear device. The extrusion may be vertical or horizontal. The presence of the chaotropic agent in the ceramic precursor batch composition may produce a composition with lower viscosity and/or a greater batch stiffening temperature, resulting in an increased rate of extrusion (feedrate) as compared to batch compositions without the chaotropic agent.

It will be appreciated that the bodies produced according to the methods or compositions disclosed herein may have any convenient size and shape and the invention is applicable to all processes in which plastic powder mixtures are shaped. The process may be especially suited to production of cellular monolith bodies such as honeycombs. Cellular bodies find use in a number of applications such as catalytic, adsorption, electrically heated catalysts, filters such as diesel particulate filters, molten metal filters, regenerator cores, etc.

In some embodiments, honeycomb densities can range from about 235 cells/cm² (1500 cells/in²) to about 15 cells/cm² (100 cells/in²). Examples of honeycombs produced by the process disclosed herein, although it is to be understood that the invention is not limited to such, include those having about 94 cells/cm² (about 600 cells/in²), or about 62 cells/cm² (about 400 cells/in²) each having wall thicknesses of about 0.1 mm (4 mils). In some embodiments, wall thicknesses can be from about 0.07 to about 0.6 mm (about 3 to about 25 mils), and in some embodiments of about 0.02-0.048 mm (1-2 mils). The method may be especially suited for extruding thin wall/high cell density honeycombs.

The extrudates can then be dried and fired according to known techniques. The addition of the chaotropic agent may allow less solvent to be used, aiding in the drying and firing of the green body. The firing conditions of temperature and time may depend on the composition and size and geometry of the body, and the invention is not limited to specific firing temperatures and times. For example, in compositions which are primarily for forming cordierite, the temperatures in some embodiments are from about 1300° C. to about 1450° C., and the holding times at these temperatures can be in some embodiments from about 1 hour to about 6 hours. For mixtures that are primarily for forming mullite, the temperatures can be in some embodiments from about 1400° C. to about 1600° C., and the holding times at these temperatures can be in some embodiments from about 1 hour to about 6 hours. For cordierite-mullite forming mixtures which yield the previously described cordierite-mullite compositions, the temperatures can be in some embodiments from about 1375° C. to about 1425° C. Firing times depend on factors such as kinds and amounts of materials and nature of equipment but in some embodiments total firing times may be from about 20 hours to about 80 hours. For metal bodies, the temperatures may be about 1000° C. to 1400° C. in a reducing atmosphere such as hydrogen. Firing times depend on factors as discussed above but may in some embodiments be at least 2 hours and typically about 4 hours. For zeolite bodies, the temperatures may be about 400° C. to 1000° C. in air. Firing times depend on factors as discussed above but may in some embodiments be about 4 hours.

### EXAMPLES

The invention will be further clarified by the following examples.

### Example 1

### Aluminum Titanate

A number of sample batches were made to demonstrate how urea can increase the batch stiffening temperature of an aluminum titanate (AT) based ceramic paste composition. Urea was added to the AT batch at levels of 1, 2 and 4% superaddition based on inorganics plus pore former. The urea was added to the water to dissolve first. The other solid dry components were mixed with a standard procedure using a Process-All plow blade mixer. The liquids (water with dissolved urea and tall oil) were spray injected into the dry batch and then all components were mixed for several minutes to homogeneously disperse the batch. Both the control (no urea) and batch with urea contained a water level of 15.5% and F-type hydroxypropyl methylcellulose (BD06A Metolose from Shin Etsu) level of 4.5% superaddition based on inorganics plus poreformer. The urea concentrations at this water level equated to 1.08, 2.15 and 4.3 m (moles urea/kg water), respectively.

After blending all the solid and liquid materials, 500 g of the damp powder batch was plasticized in a Brabender mixer at 50 rpm for 10 minutes. The paste was removed from the Brabender and loaded into a ram where the barrel was sealed under vacuum to remove air and then spaghetti extruded two times. After the spaghetti and de-airing steps, the batch was extruded into rods 1 ft long and 0.5 inches in diameter so that they could be directly loaded into a capillary rheometer for temperature sweep tests for measuring the stiffening temperature of the paste.

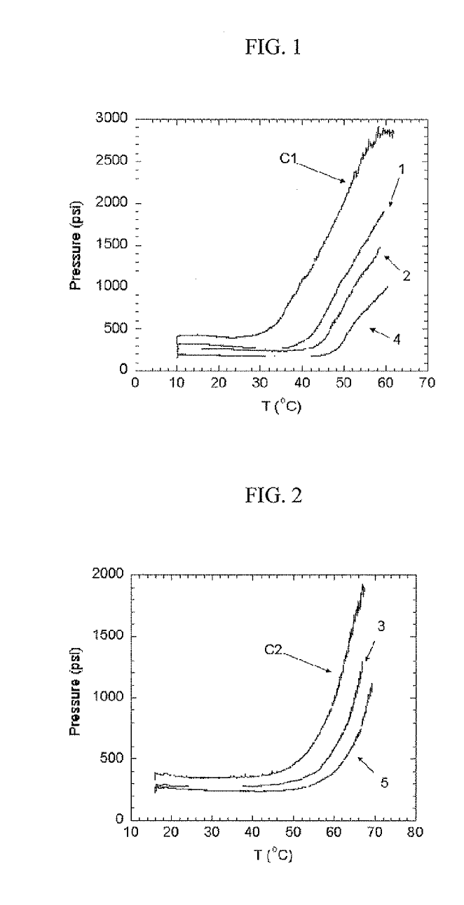

The batch stiffening temperature (Tₒₙₛₑₜ) of the control (no urea) and composition with urea was measured using a dual barrel temperature sweep method. Tₒₙₛₑₜ is defined as the temperature at which the capillary pressure increases by 15% above the stable baseline pressure during extrusion through a zero length capillary die. At this temperature the binder begins to undergo its thermal phase transition and the pressure begins to increase sharply. FIG. 1 shows the capillary temperature sweep results of the various aluminum titanate based batches with no urea (control: C1), and 1%, 2%, and 4% urea (reference numerals 1, 2, and 4, respectively). The Tₒₙₛₑₜ for each sample was 32.1° C., 39.7° C., 43.0° C., and 46.6° C. for the control (no urea), 1%, 2%, and 4% urea samples respectively.

### Example 2

### Cordierite

A number of sample batches were made to demonstrate how urea can increase the batch stiffening temperature of a cordierite ceramic paste composition. Urea was added to the cordierite ceramic paste composition at levels of 3% and 5% superaddition based on inorganics. The urea was added to the water to dissolve prior to injecting onto the solid material components. The solid dry components were mixed in the standard procedure using a Process-All plow blade mixer. The liquids (water with urea, Durasyn oil, tall oil) were spray injected into the dry batch and then all components were mixed for several minutes to homogeneously disperse the batch. Both the control (no urea) and batch with urea contained a water level of 32% and F240 Methocel (Dow Chemical) level of 5.4% superaddition based on inorganics. The urea concentration at this water level equated to 1.56 m and 2.6 m (moles urea/kg water).

After blending all the solid and liquid materials, 360 g of the damp powder batch was plasticized in a Brabender mixer at 50 rpm for 20 minutes. The paste was removed from the Brabender and loaded into a ram where the barrel was sealed under vacuum to remove air and then spaghetti extruded two times. After the spaghetti and de-airing steps, the batch was extruded into rods 1 ft long and 0.5 inches in diameter so that they could be directly loaded into a capillary rheometer for temperature sweep tests for measuring the stiffening temperature of the paste.

The batch stiffening temperature (Tₒₙₛₑₜ) of the control (no urea) and composition with urea was measured using a dual barrel temperature sweep method. FIG. 2 shows the capillary temperature sweep results of the various cordierite batches with no urea (control: C2), and 3% and 5% urea (reference numerals 3 and 5, respectively). The Tₒₙₛₑₜ for each sample was 47.3° C., 49.5° C., and 54.2° C. for the control (no urea), 3%, and 5% urea samples respectively.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. A method of producing a ceramic honeycomb body, comprising the steps of:
providing inorganic ceramic-forming ingredients;
adding a cellulose-based binder, an aqueous-based solvent, and a chaotropic agent to the inorganic ceramic-forming ingredients, wherein the chaotropic agent is optionally mixed with the aqueous-based solvent prior to adding to the inorganic ceramic-forming ingredients, wherein the chaotropic agent is urea, a urea derivative or mixtures thereof;
mixing the inorganic ceramic-forming ingredients, the binder, the solvent, and the chaotropic agent to form a precursor batch;
extruding the precursor batch into a green honeycomb body; and
firing the green honeycomb body to produce the ceramic honeycomb body.

2. The method of claim 1 wherein the chaotropic agent is urea, methylurea, ethylurea, n-butylurea, 1,3-dimethylurea, ethyleneurea, 1,1-dimethylurea, tetramethylurea, thiourea or mixtures thereof.

3. The method of claim 1 wherein the chaotropic agent has a molality of from about 0.1 molal to about 8.0 molal.

4. The method of claim 1 wherein the amount of chaotropic agent is at about the solubility limit of the agent in the solvent.

5. The method of claim 1 wherein the cellulose-based binder comprises methylcellulose, ethylhydroxy ethylcellulose, hydroxybutyl methylcellulose, hydroxymethylcellulose, hydroxypropyl methylcellulose, hydroxyethyl methylcellulose, hydroxybutyl methylcellulose, hydroxyethylcellulose, hydroxypropylcellulose, sodium carboxy methylcellulose or mixtures thereof.

6. The method of claim 1 wherein the ceramic-forming ingredients comprise cordierite or aluminum-titanate forming ingredients.

7. The method of claim 1 further comprising the step of adding up to 60 weight % of a pore forming material to the inorganic ceramic-forming materials wherein the weight % is based on 100% of the inorganic ceramic-forming ingredients.

8. The method of claim 7 wherein the pore forming material is starch or graphite.

9. The method of claim 1 wherein the green honeycomb body is formed by extrusion through a forming die.

10. The method of claim 1 wherein the precursor batch stiffens during the forming at a characteristic stiffening temperature.

11. The method of claim 10 wherein the forming comprises extruding the precursor batch via an extruder screw.

12. The method of claim 1 wherein the green honeycomb body is dried before firing.

13. A method of producing a ceramic precursor batch, comprising the steps of:
providing inorganic ceramic-forming ingredients; and
adding a cellulose-based binder, an aqueous-based solvent, and a chaotropic agent to the inorganic ceramic-forming ingredients to form the ceramic precursor batch, wherein the chaotropic agent is optionally mixed with the aqueous-based solvent prior to adding to the inorganic ceramic-forming ingredients, wherein the chaotropic agent is urea, a urea derivative or mixtures thereof.

14. The method of claim 13 wherein the chaotropic agent is urea, methylurea, ethylurea, n-butylurea, 1,3-dimethylurea, ethyleneurea, 11-dimethylurea, tetramethylurea, thiourea or mixtures thereof.

15. The method of claim 13 wherein the amount of chaotropic agent is at about the solubility limit of the agent in the solvent.

16. The method of claim 13 wherein the chaotropic agent has a molality of from about 0.1 molal to about 8.0 molal.

17. The method of claim 13 wherein the cellulose-based binder is methylcellulose, hydroxypropyl methylcellulose, or mixtures thereof.

18. A ceramic precursor batch composition, comprising:
inorganic ceramic-forming ingredients;
a cellulose-based binder;
an aqueous-based solvent; and
a chaotropic agent, wherein the chaotropic agent is urea, a urea derivative or mixtures thereof.

19. The ceramic precursor batch composition of claim 18 wherein the chaotropic agent is urea, methylurea, ethylurea, n-butylurea, 1,3-dimethylurea, ethyleneurea, 1,1-dimethylurea, tetramethylurea, thiourea or mixtures thereof.

20. The ceramic precursor batch composition of claim 18 further comprising a pore forming material, wherein the pore forming material is starch or graphite.

21. The ceramic precursor batch composition of claim 18 wherein the chaotropic agent has a molality of from about 0.1 molal to about 8.0 molal or up to the solubility limit of the agent in the solvent.

22. The ceramic precursor batch composition of claim 18 wherein the inorganic ceramic-forming material comprises cordierite or aluminum titanate-forming ingredients.

23. The ceramic precursor batch composition of claim 18 wherein the cellulose-based binder comprises methylcellulose, ethylhydroxy ethylcellulose, hydroxybutyl methylcellulose, hydroxytnethylcellulose, hydroxypropyl methylcellulose, hydroxylethyl methylcellulose, hydroxybutyl methylcellulose, hydroxyethylcellulose, hydroxypropylcellulose, sodium carboxy methylcellulose or mixtures thereof.
